(19) United States
(12) Patent Application Publication
(10) Pub. No.: US 2004/0209677 A1
(43) Pub. Date: Oct. 21, 2004

(54) Purchasing betting tickets using wireless communication network

(76) Inventors: Chang-Kyu Park, Gangmyeong-si (KR); Cheon-Mok Kim, Namyangju-si (KR)

Correspondence Address: Robert E. Bushnell, Suite 300, 1522 K Street, N.W., Washington, DC, 20005, US

(21) Appl. No.: 10/797,153

(22) Filed: Mar. 11, 2004

(30) Foreign Application Priority Data
Apr. 18, 2003 (KR) 2003-24569

(51) Int. Cl. G06F 17/00

(52) U.S. Cl. 463/29

(57) ABSTRACT

In a system and method of purchasing betting tickets using a wireless communication network, when user authentication information is received from a mobile terminal, user authentication is performed using the received authentication information, and information on the results of the user authentication is transmitted to the mobile terminal. Thereafter, when ticket purchase information is received from the mobile terminal, the betting ticket is sold through communication with a corresponding race management system according to the ticket purchase information. After the betting ticket has been sold, the ticket sale information is stored, a Short Message Service (SMS) message indicating ticket sale information is created and transmitted to the mobile terminal.

### CLAIM OF PRIORITY

This application makes reference to, incorporates the same herein, and claims all benefits accruing under 35 U.S.C. §119 from an application entitled SYSTEM AND METHOD FOR PURCHASING BETTING TICKETS BASED ON BANK ACCOUNTS USING WIRELESS COMMUNICATION NETWORK earlier filed in the Korean Intellectual Property Office on 18 Apr. 2003 and thereby duly assigned Serial No. 2003-24569.

### BACKGROUND OF THE INVENTION

1. Field of the Invention

The present invention relates generally to purchasing betting tickets using a wireless communication network and, more particularly, to purchasing betting tickets using a wireless communication network, which allow users to purchase betting tickets for various forms of racing, such as horse racing, bicycle racing and boat racing, and provides information on various forms of racing.

2. Description of the Related Art

In general, racing, such as horse racing, bicycle racing or boat racing, is a kind of adult leisure activity in which customers bet money on a horse race, bicycle race, boat race or the like and enjoy the race with enthusiasm.

Since horse racing, bicycle racing or boat racing, for example, have temporal and spatial limitations, it is difficult to participate in the racing. For example, in the case where a person residing in a rural area participates in the racing, it is difficult to purchase a betting ticket because he/she must go to a race ground or an off-track ticket office.

That is, users fill out ticket purchase slips by entering betting details, including the amount of money bet, in the slips using a computer pen, and purchase betting tickets at ticket windows. However, the conventional method is problematic in that users must visit racing grounds to purchase betting tickets and excessive time is required to purchase betting tickets.

Accordingly, to overcome the above-described problems, there was proposed a method, in which users open their accounts for ticket purchases with organizations supervising racing by registering bank accounts and personal information with the organizations, and purchase betting tickets using ticket purchase machines installed in the organization, or using Automatic Response System (ARS) systems using telephones. In this method, users who have registered with an organization supervising racing can purchase betting tickets using telephones at locations, such as work places, without visiting racing grounds, and betting money, returned money and repaid money are deposited to and drawn from their accounts.

In the conventional ticket purchasing system and method in which betting tickets are purchased through the aid of an ARS system, there arises a problem in that the time required to purchase a betting ticket is lengthened because the user must set various optional items at various steps to purchase the betting ticket.

Furthermore, since users can purchase betting tickets at designated locations when using general wired telephones, it is inconvenient to use the conventional ticket purchasing system and method. Since the amount of money in the user's bank account must be ascertained before the user can purchase a betting ticket, the detailed information of the purchased betting ticket must be confirmed through the ARS system that is inconvenient to use.

The following patents each discloses features in common with the present invention but do not teach or suggest the inventive features specifically recited in the present application: U.S. Patent Application No. 2001/0037293 to Hindman et al., entitled INTERACTIVE WAGERING SYSTEM FOR PROVIDING WAGERING INFORMATION AND METHOD OF USE, published on Nov. 1, 2001; U.S. Patent Application No. 2001/0039204 to Tanskanen, entitled MOBILE STATION FOR USE IN A BETTING SYSTEM, published on Nov. 8, 2001; U.S. Patent Application No. 2002/0049074 to Eisinger et al., entitled METHOD OF MAKING A GAME AVAILABLE FOR A MOBILE TELEPHONY TERMINAL OF A SUBSCRIBER AND PROGRAM MODULES AND MEANS THEREFOR, published on Apr. 25, 2002; U.S. Patent Application No. 2002/0068631 to Raverdy et al., entitled SYSTEM AND METHOD TO SUPPORT GAMING IN AN ELECTRONIC NETWORK, published on Jun. 6, 2002; U.S. Patent Application No. 2002/0147047 to Letovsky et al., entitled METHOD AND SYSTEM FOR REMOTE GAMING, published on Oct. 10, 2002; U.S. Patent Application No. 2003/0064805 to Wells, entitled WIRELESS GAME PLAYER, published on Apr. 3, 2003; U.S. Patent Application No. 2003/0176162 to Planki et al., entitled WIRELESS PARTICIPATION IN BETTING OR LOTTERY SYSTEMS, published on Sep. 18, 2003; U.S. Pat. No. 6,089,975 to Dunn, entitled ELECTRONIC GAMING APPARATUS WITH MEANS FOR DISPLAYING INTERACTIVE ADVERTISING PROGRAMS, issued on Jul. 18, 2000;U.S. Pat. No. 6,527,638 to Walker et al., entitled SECURE IMPROVED REMOTE GAMING SYSTEM, issued on Mar. 4, 2003; U.S. Pat. No. 6,554,709 to Brenner et al., entitled INTERACTIVE WAGERING SYSTEMS AND PROCESSES, issued on Apr. 29, 2003; U.S. Pat. No. 6,674,448 to Garahi et al., entitled INTERACTIVE WAGERING SYSTEM WITH CONTROLLABLE GRAPHIC DISPLAYS, issued on Jan. 6, 2004; and U.S. Pat. No. 6,682,421 to Rowe et al., entitled WIRELESS GAMING ENVIRONMENT, issued on Jan. 27, 2004.

### SUMMARY OF THE INVENTION

Accordingly, an object of the present invention is to provide a system and method for purchasing betting tickets using a wireless communication network, which allow users to purchase betting tickets in a simple, one-click manner by combining an existing ARS scheme with mobile communication technology.

Another object of the present invention is to provide a system and method for purchasing betting tickets using a wireless communication network, in which betting tickets can be purchased in such a way as to access a private or public wireless network through a mobile terminal, run a ticket purchase application program, set all of the optional items for a ticket purchase on a single screen, and transmit ticket purchase information via the wireless communication network, so that users can be provided with rapid and convenient ticket purchase services.

In order to accomplish the above object, the present invention provides a method comprising: receiving user authentication information from a mobile terminal via a wireless communication network to purchase a betting ticket, performing user authentication using the received authentication information, and transmitting information on results of the user authentication to the mobile terminal via the wireless communication network; receiving ticket purchase information from the mobile terminal after completion of the user authentication and selling the betting ticket through communication with a corresponding race management system according to the ticket purchase information; storing ticket sale information and creating a Short Message Service (SMS) message indicating ticket sale information after selling the betting ticket; and transmitting the SMS message indicating the ticket sale information to the mobile terminal via the wireless communication network.

The wireless communication network is one of private and public wireless communication networks, and the mobile terminal is one of a Personal Data Assistant (PDA), a Personal Communication Service (PCS) terminal, a Digital Cellular Service (DCS) terminal, a smart phone or an International Mobile Telecommunication (IMT)-2000 terminal.

The creating of the SMS message indicating the ticket sale information is performed through one of private and public wireless switching systems.

The user authentication information includes at least one of an IDentification (ID) and a password, allocated at a time of registering for a wireless ticket purchase service, and a bank account number, registered for the wireless ticket purchase service, and the ticket purchase information includes at least one of regional information, race number information, winner determination information, horse number information and betting amount information.

In accordance with another embodiment of the present invention, there is provided a method comprising: receiving user authentication information from a mobile terminal via a private wireless communication network to purchase a betting ticket, performing user authentication using the received authentication information, and transmitting information on results of the user authentication to the mobile terminal via the private wireless communication network; receiving ticket purchase information from the mobile terminal via the private wireless communication network after completion of the user authentication and selling the betting ticket through communication with a corresponding race management system according to the ticket purchase information; storing ticket sale information and transmitting a request for creation of a SMS message indicating ticket sale information to a private wireless switch after selling the betting ticket; and creating the SMS message indicating the ticket sale information in the private wireless switch in response to the request for the creation of the SMS message indicating ticket sale information, and transmitting the SMS message indicating the ticket sale information to the mobile terminal via the private wireless communication network. In accordance with another embodiment of the present invention, there is provided a method

In accordance with another embodiment of the present invention, there is provided a method comprising: receiving user authentication information from a mobile terminal via a public wireless communication network to purchase a betting ticket, performing user authentication using the received authentication information, and transmitting information on results of the user authentication to the mobile terminal via the public wireless communication network; receiving ticket purchase information from the mobile terminal via the public wireless communication network after completion of the user authentication and selling the betting ticket through communication with a corresponding race management system according to the ticket purchase information; storing ticket sale information and transmitting a request for creation of an SMS message indicating ticket sale information to a public wireless switch after the betting ticket is sold; and creating the SMS message indicating the ticket sale information in the public wireless switch and transmitting the SMS message to the mobile terminal via the public wireless communication network in response to the request for the creation of the SMS message indicating ticket sale information. The optional items include a regional item, a race number item, a winner determination method item, a horse number item and a betting amount item.

In accordance with another embodiment of the present invention, there is provided a method comprising: running a ticket purchase application program adapted to display a user authentication screen; transmitting this user authentication information to a betting ticket purchase system via a mobile communication system after a user enters user authentication information in the authentication screen; receiving results of user authentication from the betting ticket purchase system, and displaying all of the optional items for a ticket purchase on a single screen when the user authentication succeeds; transmitting set ticket purchase information to the mobile communication system after a user has set all of the optional items displayed on the single screen; and receiving and sequentially displaying an SMS message indicating ticket sale information according to the ticket purchase information and a SMS message indicating winning information according to results of a race from the betting ticket purchase system.

In accordance with another embodiment of the present invention, there is provided a method comprising: running a ticket purchase application program in mobile terminal to transmit user authentication information to an ARS sale server through a wireless network system; receiving and authenticating the user authentication information in the ARS sale server and transmitting the results of the user authentication to the mobile terminal through the wireless network system; displaying all optional items on a single screen of the mobile terminal after the user authentication has been completed, and transmitting set ticket purchase information to a ticket sale processing system through the wireless network system and the ARS sale server after the user has set all of the optional items; selling a betting ticket in the ticket sale processing system according to the ticket purchase information and transmitting ticket sale information to the ARS sale server after ticket purchase information has been received from the mobile communication terminal via a public wireless network; storing the ticket sale information in the ARS sale server and transmitting a request for creation of a SMS message indicating ticket sale information to the wireless network system after receiving the ticket sale information; and creating and transmitting the SMS message from the wireless network system to the mobile terminal indicating the ticket sale information in response to the request for the creation of the SMS message indicating the ticket sale information.

In accordance with another embodiment of the present invention, there is provided a system comprising: an ARS ticket sales server adapted to transmit a request for a ticket purchase according to ticket purchase information to a betting ticket sale system in response to receiving the ticket purchase information through a mobile terminal, and to transmit a request to create an SMS message indicating ticket sale information in response to the ticket sale information received from the betting ticket sale system; and an ARS ticket sales server adapted to transmit a request for a ticket purchase according to ticket purchase information to a betting ticket sale system in response to receiving the ticket purchase information through a mobile terminal, and to transmit a request to create an SMS message indicating ticket sale information in response to the ticket sale information received from the betting ticket sale system; and a wireless data transmission and reception network adapted to provide the ticket purchase information, transmitted from the mobile terminal via the wireless network, to the ticket sales server, to create an SMS message indicating the ticket sale information in response to a request for creation of the SMS message indicating the ticket sale information, and to transmit the SMS message to the mobile terminal via the wireless network.

The wireless network is one of private or public wireless network, and the wireless data transmission and reception means is one of private and public wireless switching systems, each including a SMS message creation unit.

The ticket sale means comprises a wireless network-interworking API for changing data, which is received and is transmitted, in format; an authentication unit for performing user authentication for a ticket purchase; and a storage unit for storing the ticket purchase information and the ticket sale information transmitted from the betting ticket sale system.

In accordance with another embodiment of the present invention, there is provided a system comprising: a wireless network-interworking API, included with an ARS server of an ARS system, and adapted to convert ticket purchase information into data having a format appropriate to the ARS server in response ticket purchase information received from a mobile terminal, to transmit a request for a ticket purchase corresponding to the converted ticket purchase data to a ticket sale processing system, and to transmit a request for creation of a SMS message indicating ticket sale information in response to receiving the ticket sale information from the ticket sale processing system; and a wireless data transmission and reception network adapted to provide the ticket purchase information, transmitted from the mobile terminal via the wireless network, to the wireless network-interworking API, and to create an SMS message indicating the ticket sale information in response to a request for the creation of the SMS message transmitted from the wireless network-interworking API, and to transmit the SMS message to the mobile terminal via the wireless network.

The ARS server comprises an authentication unit for performing user authentication; and a storage unit for storing the ticket purchase information and the ticket sale information transmitted from the betting ticket sale processing system.

In accordance with another embodiment of the present invention, there is provided a mobile terminal comprising: a ticket purchase application program module adapted to display a user authentication screen in response to running a ticket purchase application program and adapted to display a ticket purchase screen, including all optional items to enable a user to set all of the optional information for a ticket purchase, in response to a completion of a user authentication; and a wireless data transmission and reception module adapted to transmit user authentication information and ticket purchase information to a betting ticket sale system, and to receive an SMS message indicating ticket sale information and a SMS message indicating winning information from the betting ticket sale system via a wireless communication network.

The ticket purchase screen displayed by the ticket purchase application program includes at least one of a regional option field, a race number option field, a winner determination option field, a horse number option field and a betting amount option field.

The mobile terminal further comprises an additional betting button for allowing the user to additionally purchase a betting ticket after all the optional items are set on the ticket purchase screen displayed by the ticket purchase application program; and a temporary data storage unit for temporarily storing previously set ticket purchase information when the additional betting button is pushed and additional ticket purchase information is set.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a network configuration diagram of a conventional system for purchasing betting tickets based on bank accounts using an ARS system;

FIG. 2 is a flow diagram showing a conventional method of purchasing betting tickets based on bank accounts using the conventional betting ticket purchasing system;

FIG. 3 is a network configuration diagram showing a system for purchasing betting tickets based on bank accounts using the mobile communication system in accordance with an embodiment of the present invention;

FIG. 4 is a diagram showing an example of the system configuration of the betting ticket purchasing system using the wireless communication system in accordance with an embodiment of the present invention;

FIG. 5 is a diagram showing an example of the purchase screen of the mobile terminal that allows the user to purchase the betting ticket in the betting ticket purchasing system using the wireless communication network in accordance with an embodiment of the present invention; and

FIG. 6 is a flow diagram showing a method of purchasing betting tickets based on back accounts using a wireless communication network in accordance with an embodiment of the present invention.

### DESCRIPTION OF THE PREFERRED EMBODIMENT

Reference now should be made to the drawings, in which the same reference numerals are used throughout the different drawings to designate the same or similar components.

A conventional system and method for purchasing betting tickets based on bank accounts using an ARS system is described below.

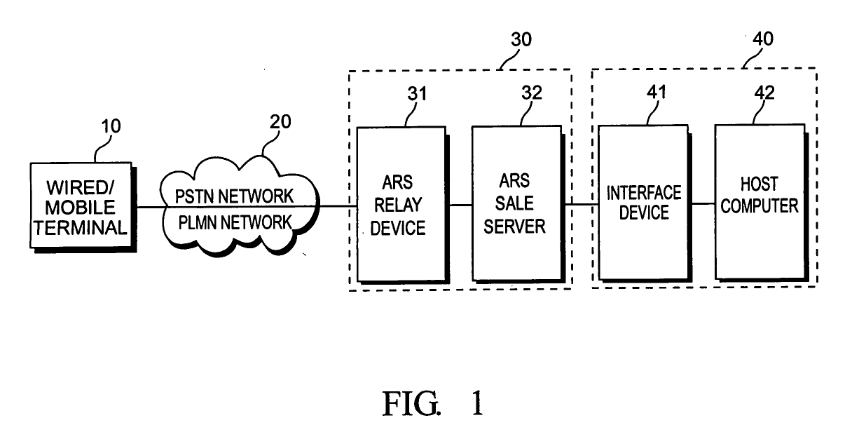

FIG. 1 is a network configuration diagram of the conventional system for purchasing betting tickets based on bank accounts using an ARS system. The conventional betting ticket purchasing system can include an ARS system 30 having an ARS relay device 31 and an ARS sale server 32, and a ticket sale processing system 40 having an interface device 41 and a host computer 42. In this case, the ARS system 30 can be connected to a wired/mobile terminal 10 via a Public Switched Telephone Network (PSTN)/Public Land Mobile Network (PLMN) 20. That is, a wired terminal is connected to the ARS system 30 via the PSTN, while a mobile terminal is connected to the ARS system 30 via the PLMN.

If a call signal for requesting a ticket purchase is received from the wired/mobile terminal 10 via the PSTN/PLMN 20, the ARS relay device 31 of the ARS system 30 transmits a voice message for guiding a user on the ticket purchase to the wired/mobile terminal 10 via the PSTN/PLMN 20 in response to the call signal, and converts Dual Tone MultiFrequency (DTMF) signals for making selections for the ticket purchase, transmitted from the wired/mobile terminal 10, into digital signals and transmits these digital signals to the ARS sale server 32.

The ARS sale server 32 of the ARS system 30 stores data transmitted from the ARS relay device 31, converts this data into Transmission Control Protocol (TCP)/Internet Protocol (IP) format data, and then transmits this TCP/IP format data to the host computer 42 of the ticket sale processing system 40 through the interface device 41.

The interface device 41 of the ticket sale processing system 40 acts as a data interface between the host computer 42 and the ARS sale server 32. The host computer 42 performs a ticket sale process using ticket purchase data transmitted from the interface device 41, and provides ticket sale information to the ARS sale server 32 through the interface device 41.

The ARS sale server 32 stores the ticket sale information, transmitted from the host computer 42, in the database (not shown) thereof, and then transmits the ticket sale information to the ARS relay device 31. Then, the ARS relay device 31 converts the ticket sale information into voice data and provides the voice data to the wired/mobile terminal 10 via the PSTN/PLMN 20.

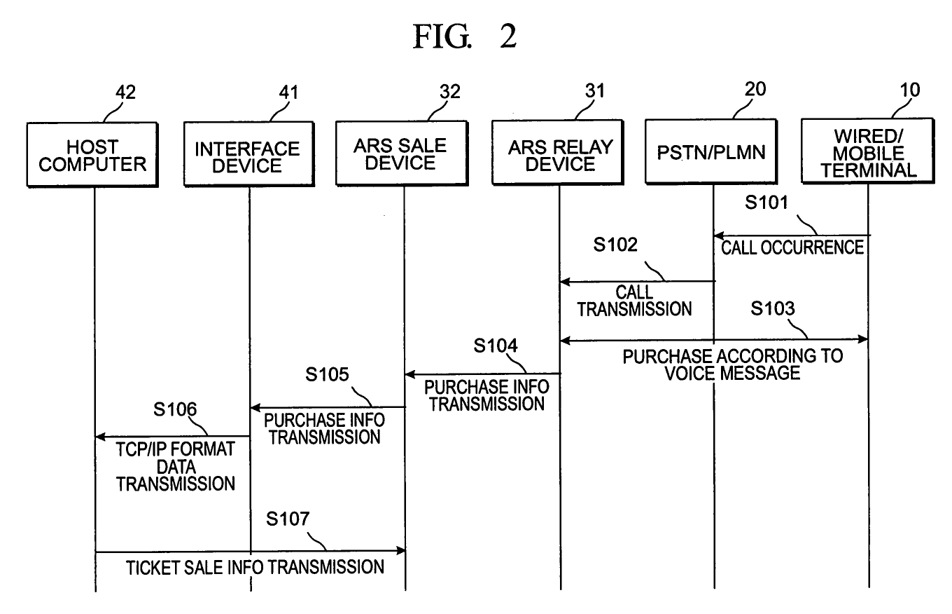

A conventional method of purchasing betting tickets based on back accounts using the conventional betting ticket purchasing system constructed as described above is described below with reference to FIG. 2.

FIG. 2 is a flow diagram showing the conventional method of purchasing betting tickets based on bank accounts using the conventional betting ticket purchasing system.

When a call signal for requesting a ticket purchase is received from a user terminal, that is, the wired/mobile terminal 10, the call signal is transmitted to the ARS relay device 31 of the ARS system 30 via the PSTN/PLMN 20 at steps S101 and S102.

The ARS relay device 31 of the ARS system 30 transmits a voice message for guiding a user on the ticket purchase to the wired/mobile terminal 10 via the PSTN/PLMN 20 in response to the call signal transmitted from the wired/mobile terminal 10. Accordingly, the user sets optional items for the ticket purchase using the dial buttons of the wired/mobile terminal 10 in response to a voice message transmitted from the ARS relay device 31.

The DTMF signals representing the set optional items are transmitted to the ARS relay device 31 via the PSTN/PLMN 20 at step S103.

The ARS relay device 31 analyzes the DTMF signals representing the set optional items transmitted from the wired/mobile terminal 10 via the PSTN/PLMN 20, and provides ticket purchase information, obtained by the analysis, to the ARS sale server 32 at step S104.

The ARS sale server 32 transmits the ticket purchase information provided from the ARS relay device 31 to the interface device 41 of the ticket sale processing system 40 at step S105.

The interface device 41 converts the ticket purchase information provided from the ARS system 30 into the TCP/IP format data, and transmits the TCP/IP format data to the host computer 42 at step S106.

Thereafter, the host computer 42 sells a betting ticket according to the TCP/IP format data provided from the interface device 41, and then transmits ticket sale information to the ARS sale server 32 at step S107. In this case, the host computer 42 compares the amount of money in the user's bank account with the amount of money bet, and issues the betting ticket only if the amount of money in the user's bank account is equal to or greater than the amount of money bet. The ticket sale processing system 40 can be directly operated by an organization that supervises the racing.

The ARS sale server 32 stores the ticket sale information transmitted from the host computer 42 in the database of the ARS sale server 32, and then transmits the ticket sale information to the wired/mobile terminal 10 via the PSTN/PLMN 20 in the form of a voice message.

A system and method for purchasing betting tickets based on bank accounts using a wireless communication network in accordance with an embodiment of the present invention are described in detail below with reference to the accompanying drawings.

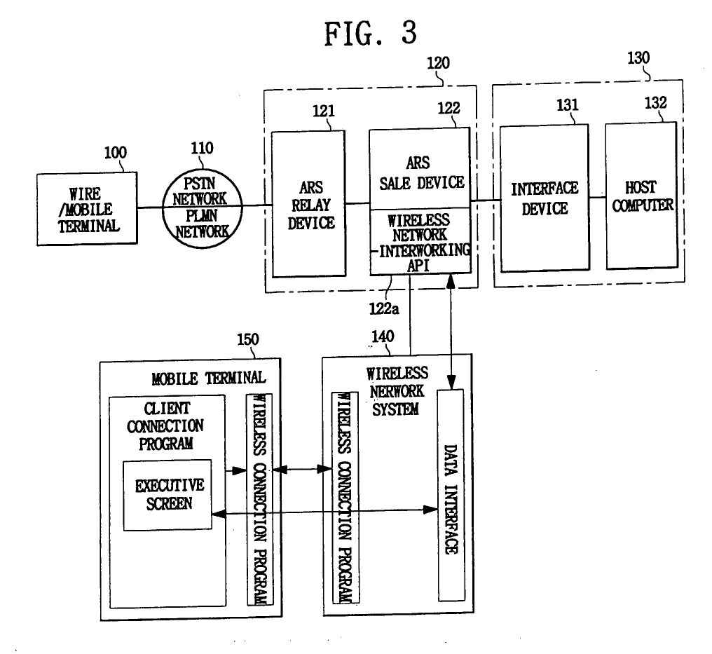

FIG. 3 is a network configuration diagram of the betting ticket purchasing system using the mobile communication system in accordance with a embodiment of the present invention, in which descriptions of the same elements as the network configuration of FIG. 1 are omitted for convenience of description below.

As illustrated in FIG. 3, the betting ticket purchasing system in accordance with an embodiment of the present invention includes a mobile terminal 150, a wireless network system 140, and an ARS system 120 having an ARS relay device 121 and an ARS sale server 122.

The ARS sale server 122 of the ARS system 120 includes a wireless network system-interworking Application Process Invocation (API) 122a that transmits and receives communication packet data while interworking with the wireless network system 140.

The wireless network system-interworking API 122a converts the data of a ticket purchase request, transmitted from the wireless network system 140, into data having a format that can be processed in the ARS sale server 122, transmits the converted data to the ticket sale processing system 130, and transmits issued ticket data to the wireless network system 140.

The mobile terminal 150 is provided with a communication module and a client application program module. The client application program module displays optional items on one screen so that the user can set all the optional items on a single screen. The mobile terminal 150 can be a Personal Data Assistant (PDA), a Personal Communication Service (PCS) terminal, a Digital Cellular Service (DCS) terminal, a smart phone or an International Mobile Telecommunication (IMT)-2000 terminal.

The mobile terminal 150 can be connected to the wireless network system 149 via a private or public wireless communication network. In this case, for the public wireless communication network, the wireless network system 140 can include a base station, a control station and a switch, whereas for the private wireless communication network, the wireless network system 140 can include a private base station, a private control station and a private switch.

The mobile terminal 150 can be provided with an application program and a wireless connection program. The application program is a client application program capable of interworking with the ARS sale server 122. A commercial Operating System (OS), such as Palm OS, Microsoft Win CE/Pocket PC OS or the like can be used as the wireless connection program. In a PDA, the wireless connection program can be a communication program that meets API specifications designated by the communication module connection program of OS thereof.

The wireless network system 140 includes a wireless connection program capable of wirelessly connecting with the wireless connection program and a data interface for transmitting and receiving data to and from the wireless network system-interworking API 122a.

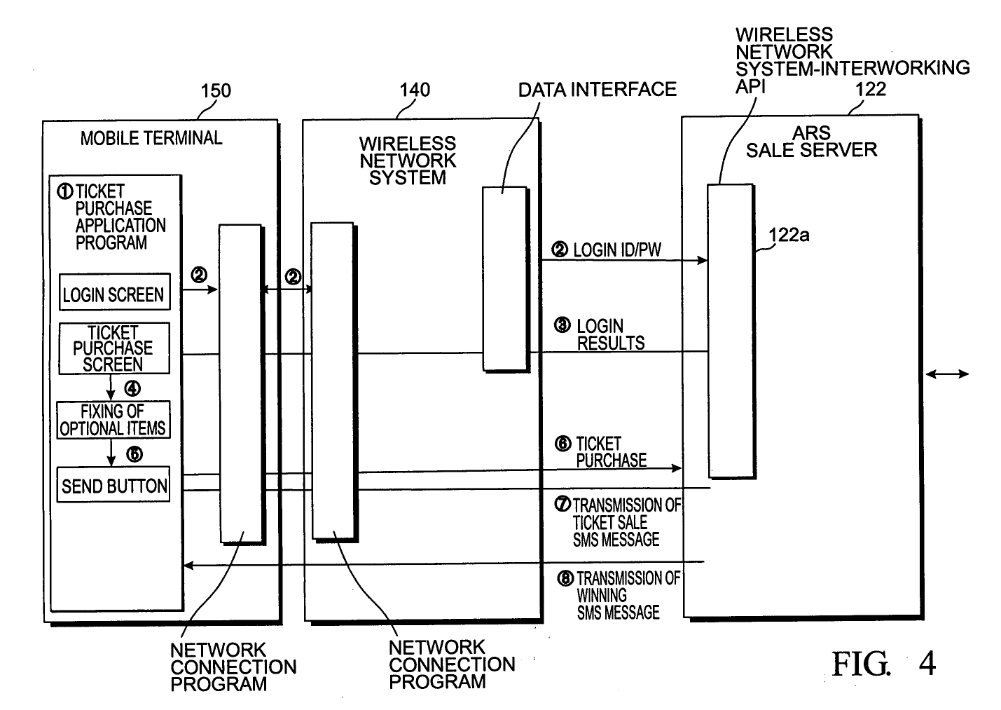

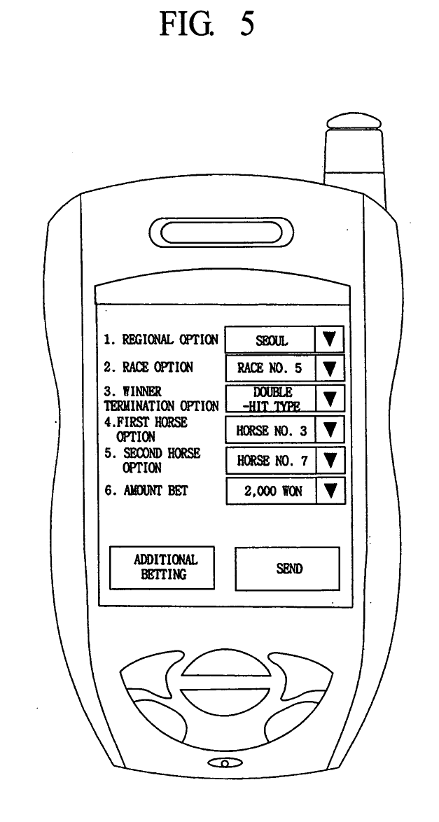

The operation of the betting ticket purchasing system using the mobile communication network is described with reference to FIGS. 4 and 5.

FIG. 4 is a diagram showing an example of the system configuration of the betting ticket purchasing system using the wireless communication system in accordance with an embodiment of the present invention. FIG. 5 is a diagram showing an example of the purchase screen of the mobile terminal that allows the user to purchase the betting ticket in the betting ticket purchasing system using the wireless communication network in accordance with an embodiment of the present invention.

When the user runs a ticket purchase application program by pushing a ticket purchase application program running button, a login screen for authenticating the mobile terminal 150 and the user (a subscriber) is displayed on the display of the mobile terminal 150. In this case, to purchase a betting ticket, the user must register the bank account number and personal information thereof with the ticket sale processing system, and be allocated and store an IDentification (ID) and a password.

Accordingly, the user can try to log in by entering the ID and password thereof in ID and password fields indicated on a login screen.

The information of the ID and password entered by the user through the mobile terminal 150 is transmitted to the network connection program of the wireless network system 140 through the wireless connection program (network connection program) of the mobile terminal 150.

The network connection program of the wireless network system 140 provides the information of the ID and password, transmitted from the mobile terminal 150, to the wireless network-interworking API 122a of the ARS sale server 122 through the data interface.

The ARS sale server 122 searches the database thereof for an ID and a password, which coincide with the information of the ID and password transmitted from the wireless network system 140 to the wireless network system-interworking API 122a by comparing the transmitted ID and password with a plurality of IDs and passwords stored in the database.

If, as the result of the search, the coincident ID and password exist, the ARS sale server 122 provides login result information (authentication information) to the mobile terminal 150 through the wireless network system 140. In the case where the login succeeds, the ARS sale server 122 secures a data communication channel between the wireless network system 140 and the mobile terminal 150.

In the case where the login succeeds, the mobile terminal 150 displays a ticket purchase screen for purchasing the betting ticket on the display thereof by running the client application program. In contrast, in the case where the login fails, a login failure message is displayed on the display of the mobile terminal 150 so that the user can reenter the ID and password thereof. In the above case, all the optional items for a ticket purchase must be displayed on a single screen.

As a result, the user can set all the optional items for the ticket purchase on the single screen displayed on the mobile terminal 150 thereof. In this case, the optical items for the ticket purchase can include a regional item, a race number item, a winner determination type item, a horse number item and the amount of money bet, as shown in FIG. 5. Furthermore, if the user wants to purchase one more betting ticket after setting all of the optional items on the screen shown in FIG. 5, the user can purchase the betting ticket by clicking on an additional betting button. That is, when the user clicks on the additional betting button shown in FIG. 5 to purchase an additional betting ticket, the previously set ticket purchase information is stored in the temporary data storage of the mobile terminal 150 (for example, a buffer) and a screen displays optional items that must be set to purchase an additional betting ticket. When the user clicks on a SEND button after setting all of the optional items to purchase the one more betting tickets, the previously set ticket purchase information stored in the temporary data storage of the mobile terminal 150, together with currently set ticket purchase information, are both transmitted to the wireless network system 140 at the same time. With this, a plurality of betting tickets can be purchased successively.

When the user clicks on the SEND button shown in FIG. 5 after setting all of the optional items for the ticket purchase, the ticket purchase request information, including the ticket purchase information, is transmitted to the ARS sale server 122 through the data interface of the wireless network system 140.

The wireless network system-interworking API 122a of the ARS sale server 122 converts the ticket purchase information into ticket purchase information having an appropriate format, and provides the converted ticket purchase information to the host computer 132 through the interface device 131 of the ticket sale processing system 130.

Thereafter, the ticket sale processing system 130 checks the amount of money bet based on the ticket purchase information, and issues the betting ticket if the amount of money in the user's bank account is equal to or greater than the amount of money bet. In this case, the host computer 132 is provided with a financial clearing system (not shown), and therefore, can ascertain the amount of remaining money in the user's registered bank account and perform a financial clearing following the ticket purchase through the wireless communication network.

Ticket sale information is provided to the ARS sale server 122 through the interface device 131 of the ticket sale processing system 130. The ARS sale server 122 stores the ticket sale information in the database thereof, and transmits a request for the transmission of a SMS message indicating the completion of the ticket sale to the wireless network system 140 through the wireless network-interworking API 122a.

The wireless network system 140 creates a SMS message indicating the completion of the ticket sale in response to the request for the transmission of SMS message indicating the completion of the ticket sale transmitted from the ARS sale server 120, and transmits the SMS message indicating the completion of the ticket sale to the mobile terminal 150 so that the mobile terminal 150 can display the SMS message indicating the completion of the ticket sale. In this case, the wireless network system 140 can be provided with a SMS server that is capable of providing an SMS. Such an SMS server can be formed in the ARS sale server 120. Furthermore, in the case where the wireless network system 140 is a private or public switch, the SMS can be carried out using an existing SMS server without an additional SMS server.

Accordingly, the user confirms the completion of the ticket purchase through the SMS message indicating the completion of the ticket sale displayed on the mobile terminal 150.

Furthermore, after the race is finished, the ARS sale server 120 can provide a SMS message indicating the winner and the amount of winnings of the user based on the results of the race to the user's mobile terminal 150 through the wireless network system 140.

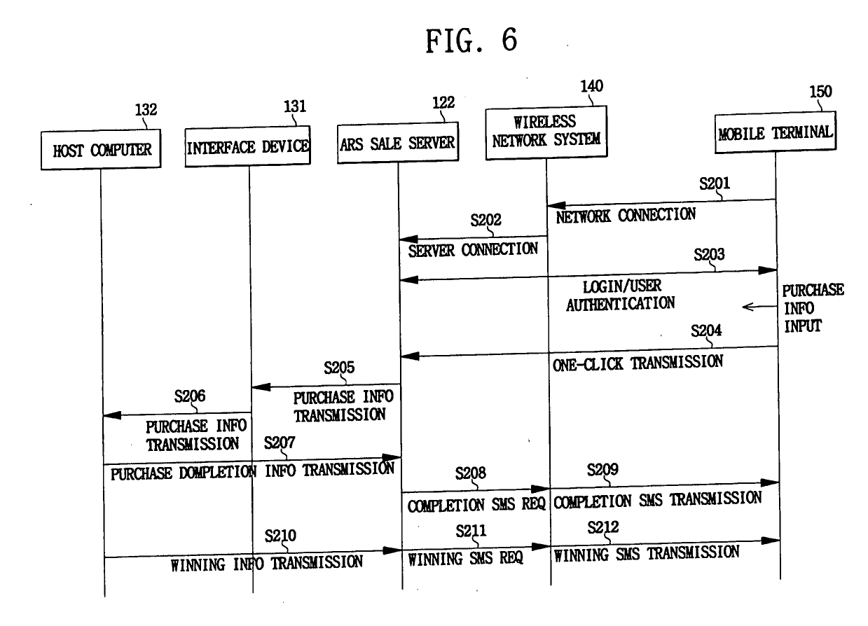

A method of purchasing betting tickets based on bank accounts using the wireless communication network, which corresponds to the operation of the betting ticket purchasing system using the wireless communication network, is described below with reference to FIG. 6.

FIG. 6 is a flow diagram showing the betting ticket purchasing method using the wireless communication network in accordance with an embodiment of the present invention.

The user runs the ticket purchase application program of the mobile terminal 150 so as to purchase the betting ticket through the mobile terminal 150.

The login screen is displayed by the run ticket purchase application program on the display of the mobile terminal 150 so as to allow the user to enter the ID and password thereof. In this case, the login screen can further include a field for the entrance of a user's bank account number.

The user accesses the wireless network system 140 by entering user's previously allocated ID and password in the login screen at step S201.

The wireless network system 140 provides the information of the ID and password transmitted from the mobile terminal 150 to the ARS sale server 122 of the ARS system 120 at step S202.

The ARS sale server 122 performs user authentication using the information of the ID, password and bank account number provided through the wireless network system 140 at step S203.

The ARS sale server 122 provides results of the user authentication to the mobile terminal 150 of the user through the wireless network system 140. When the user authentication is successfully performed, the mobile terminal 150 displays the ticket purchase screen using the ticket purchase application program, as shown in FIG. 5.

The user sets the optional items on the ticket purchase screen. When the user clicks on the SEND button after setting all of the optional items, the ticket purchase information set by the user is transmitted to the ARS sale server 122 through the wireless network system 140. In brief, in the present invention, all the optional items for the ticket purchase are displayed on a single screen, so that the user can set all of the optional items on the single screen and all of the set purchase information is transmitted by one click.

The ARS sale server 122 stores the ticket purchase information, transmitted through the wireless network system 140, in the database thereof, and, thereafter, transmits the ticket purchase information to the host computer 132 through the interface device 131 of the ticket sale processing system 130 at steps S205 and S206. In this case, the interface device 131 of the ticket sale processing system 130 functions as a data interface between the ARS sale server 120 and the host computer 132.

The host computer 132 of the ticket sale processing system 130 issues the betting ticket according to the ticket purchase information transmitted through the interface device 131, and transmits ticket sale information to the ARS sale server 122 through the interface device 131 at step S207. At this time, the host computer 132 compares the amount of money in the user's bank account with the amount of money bet, which is included in the ticket purchase information, through the financial clearing system. If, as the result of the comparison, the amount of money in a user's bank account is equal to or greater than the amount of money bet, the host computer 132 allows the user to purchase the betting ticket. Otherwise, the host computer 132 provides a message indicating the rejection of the ticket purchase to the mobile terminal 150.

The ARS sale server 122 stores the ticket sale information, transmitted from the host computer 132 through the interface device 131, in the database thereof, and transmits a request for the transmission of an SMS message indicating the completion of the ticket sale to the wireless network system 140 through the wireless network-interworking API 122a at step S208.

The wireless network system 140 creates the SMS message indicating the completion of the ticket sale in response to the request for the transmission of the SMS message indicating the completion of the ticket sale, and transmits this SMS message to the mobile terminal 150 at step S209.

Accordingly, the user confirms the completion of the ticket purchase through the SMS message indicating the completion of the ticket sale displayed on the mobile terminal 150.

Additionally, the host computer 132 transmits winner information to the ARS sale server 122 through the interface device 131 at the time of the completion of the race at step S210, and the ARS sale server 122 transmits a request for the creation of a SMS message indicating the winner information to the wireless network system 140 at step S211.

Accordingly, the wireless network system 140 creates the SMS message indicating the winner and the amount of winnings, and provides this message to the mobile terminal 150 at step S212.

The betting ticket purchasing system and method using the wireless communication network in accordance with the present invention are summarized below.

After accessing the wireless network system through the mobile terminal so as to purchase the betting ticket, the user accesses the ARS sale server using an exclusive browser based on the ticket purchase application program of the mobile terminal.

Subsequently, the ARS sale server performs the user authentication. When the user authentication is completed, the ticket purchase screen is displayed on the display of the mobile terminal. The user purchases the betting ticket by setting the optional items on the displayed ticket purchase screen.

When the user clicks on the SEND button after setting all of the optional items, the set ticket purchase information is transmitted to the ARS sale server through the wireless network system.

The ARS sale server sells the betting ticket by communicating with the host computer of the ticket sale processing system through the interface device.

The betting ticket sold as described above is transmitted to the wireless network system, and the wireless network system creates the SMS message indicating ticket sale information and transmits this SMS message to the mobile terminal. However, the above-described service is limited to users that have registered their bank accounts with organizations supervising racing, such as horse racing, bicycle racing or boat racing.

Although, in the above-described embodiments, the present invention has been described as being applied to the public wireless communication network, it could be easily understood by those skilled in the art that the present invention can be applied to a private wireless communication network. That is, the betting ticket purchasing method using the wireless communication network can be utilized in the case where the wireless network system is replaced with a private switch and the private switch is connected to the ARS sale server.

As descried above, the present invention provides a system and method for purchasing betting tickets based on bank accounts using a wireless communication network, which allow users to purchase betting tickets in not a complicated manner but in a simple manner by combining an existing ARS scheme with mobile communication technology, and which allows each betting ticket to be purchased in such a way as to access a private or public wireless network through a mobile terminal, run a ticket purchase application program, set all of the optional items for a ticket purchase on a single screen and transmit ticket purchase information via the wireless communication network, so that users can be provided with rapid and convenient ticket purchase services.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method comprising:
receiving user authentication information from a mobile terminal via a wireless communication network to purchase a betting ticket, performing user authentication using the received authentication information, and transmitting information on results of the user authentication to the mobile terminal via the wireless communication network;
receiving ticket purchase information from the mobile terminal after completion of the user authentication and selling the betting ticket through communication with a corresponding race management system according to the ticket purchase information;
storing ticket sale information and creating a Short Message Service (SMS) message indicating ticket sale information after selling the betting ticket; and
transmitting the SMS message indicating the ticket sale information to the mobile terminal via the wireless communication network.

2. The method according to claim 1, wherein the wireless communication network is one of private and public wireless communication networks.

3. The method according to claim 1, wherein the mobile terminal is one of a Personal Data Assistant (PDA), a Personal Communication Service (PCS) terminal, a Digital Cellular Service (DCS) terminal, a smart phone or an International Mobile Telecommunication (IMT)-2000 terminal.

4. The method according to claim 1, wherein the creating of the SMS message indicating the ticket sale information is performed through one of private and public wireless switching systems.

5. The method according to claim 1, wherein the user authentication information includes at least one of an IDentification (ID) and a password, allocated at a time of registering for a wireless ticket purchase service, and a bank account number, registered for the wireless ticket purchase service.

6. The method according to claim 1, wherein the ticket purchase information includes at least one of regional information, race number information, winner determination information, horse number information and betting amount information.

7. A method comprising:
receiving user authentication information from a mobile terminal via a private wireless communication network to purchase a betting ticket, performing user authentication using the received authentication information, and transmitting information on results of the user authentication to the mobile terminal via the private wireless communication network;
receiving ticket purchase information from the mobile terminal via the private wireless communication network after completion of the user authentication and selling the betting ticket through communication with a corresponding race management system according to the ticket purchase information;
storing ticket sale information and transmitting a request for creation of a SMS message indicating ticket sale information to a private wireless switch after selling the betting ticket; and
creating the SMS message indicating the ticket sale information in the private wireless switch in response to the request for the creation of the SMS message indicating ticket sale information, and transmitting the SMS message indicating the ticket sale information to the mobile terminal via the private wireless communication network.

8. A method comprising:
receiving user authentication information from a mobile terminal via a public wireless communication network to purchase a betting ticket, performing user authentication using the received authentication information, and transmitting information on results of the user authentication to the mobile terminal via the public wireless communication network;
receiving ticket purchase information from the mobile terminal via the public wireless communication network after completion of the user authentication and selling the betting ticket through communication with a corresponding race management system according to the ticket purchase information;
storing ticket sale information and transmitting a request for creation of an SMS message indicating ticket sale information to a public wireless switch after the betting ticket is sold; and
creating the SMS message indicating the ticket sale information in the public wireless switch and transmitting the SMS message to the mobile terminal via the public wireless communication network in response to the request for the creation of the SMS message indicating ticket sale information.

9. A method comprising:
running a ticket purchase application program adapted to display a user authentication screen;
transmitting this user authentication information to a betting ticket purchase system via a mobile communication system after a user enters user authentication information in the authentication screen;
receiving results of user authentication from the betting ticket purchase system, and displaying all of the optional items for a ticket purchase on a single screen when the user authentication succeeds;
transmitting set ticket purchase information to the mobile communication system after a user has set all of the optional items displayed on the single screen; and
receiving and sequentially displaying an SMS message indicating ticket sale information according to the ticket purchase information and a SMS message indicating winning information according to results of a race from the betting ticket purchase system.

10. A method comprising:
running a ticket purchase application program in mobile terminal to transmit user authentication information to an ARS sale server through a wireless network system;
receiving and authenticating the user authentication information in the ARS sale server and transmitting the results of the user authentication to the mobile terminal through the wireless network system;
displaying all optional items on a single screen of the mobile terminal after the user authentication has been completed, and transmitting set ticket purchase information to a ticket sale processing system through the wireless network system and the ARS sale server after the user has set all of the optional items;
selling a betting ticket in the ticket sale processing system according to the ticket purchase information and transmitting ticket sale information to the ARS sale server after ticket purchase information has been received from the mobile communication terminal via a public wireless network;
storing the ticket sale information in the ARS sale server and transmitting a request for creation of a SMS message indicating ticket sale information to the wireless network system after receiving the ticket sale information; and
creating and transmitting the SMS message from the wireless network system to the mobile terminal indicating the ticket sale information in response to the request for the creation of the SMS message indicating the ticket sale information.

11. A system comprising:
an ARS ticket sales server adapted to transmit a request for a ticket purchase according to ticket purchase information to a betting ticket sale system in response to receiving the ticket purchase information through a mobile terminal, and to transmit a request to create an SMS message indicating ticket sale information in response to the ticket sale information received from the betting ticket sale system; and
a wireless data transmission and reception network adapted to provide the ticket purchase information, transmitted from the mobile terminal via the wireless network, to the ticket sales server, to create an SMS message indicating the ticket sale information in response to a request for creation of the SMS message indicating the ticket sale information, and to transmit the SMS message to the mobile terminal via the wireless network.

12. The system according to claim 11, wherein the wireless network is one of a private or public wireless network.

13. The system according to claim 11, wherein the wireless data transmission and reception network is one of private and public wireless switching systems, each including an SMS message creation unit.

14. The system according to claim 11, wherein the ticket sales server comprises:
a wireless network-interworking API adapted to change received and transmitted data formats;
an authentication unit adapted to perform user authentication for a ticket purchase; and
a storage unit adapted to store the ticket purchase information and the ticket sale information transmitted from the betting ticket sale system.

15. A system comprising:
a wireless network-interworking API, included with an ARS server of an ARS system, and adapted to convert ticket purchase information into data having a format appropriate to the ARS server in response ticket purchase information received from a mobile terminal, to transmit a request for a ticket purchase corresponding to the converted ticket purchase data to a ticket sale processing system, and to transmit a request for creation of a SMS message indicating ticket sale information in response to receiving the ticket sale information from the ticket sale processing system; and
a wireless data transmission and reception network adapted to provide the ticket purchase information, transmitted from the mobile terminal via the wireless network, to the wireless network-interworking API, and to create an SMS message indicating the ticket sale information in response to a request for the creation of the SMS message transmitted from the wireless network-interworking API, and to transmit the SMS message to the mobile terminal via the wireless network.

16. The system according to claim 15, wherein the ARS server comprises:
an authentication unit adapted to perform user authentication; and
a storage unit adapted to store the ticket purchase information and the ticket sale information transmitted from the betting ticket sale processing system.

17. A mobile terminal comprising:
a ticket purchase application program module adapted to display a user authentication screen in response to running a ticket purchase application program and adapted to display a ticket purchase screen, including all optional items to enable a user to set all of the optional information for a ticket purchase, in response to a completion of a user authentication; and
a wireless data transmission and reception module adapted to transmit user authentication information and ticket purchase information to a betting ticket sale system, and to receive an SMS message indicating ticket sale information and a SMS message indicating winning information from the betting ticket sale system via a wireless communication network.

18. The mobile terminal according to claim 17, wherein the ticket purchase screen displayed by the ticket purchase application program includes at least one of a regional option field, a race number option field, a winner determination option field, a horse number option field and a betting amount option field.

19. The mobile terminal according to in claim 18, further comprising:
an additional betting button adapted to enable the user to additionally purchase a betting ticket after all of the optional items have been set on the ticket purchase screen displayed by the ticket purchase application program; and
a temporary data storage unit adapted to temporarily store previously set ticket purchase information in response to the additional betting button being pushed and additional ticket purchase information being set.
